(19) United States
(12) Patent Application Publication
(10) Pub. No.: US 2014/0360681 A1
(43) Pub. Date: Dec. 11, 2014

(54) Venetian blind with cord retractor

(71) Applicant: Norbert Marocco, Toronto (CA)

(72) Inventor: Norbert Marocco, Toronto (CA)

(21) Appl. No.: 13/999,620

(22) Filed: Mar. 13, 2014

(30) Foreign Application Priority Data
Jun. 7, 2013 (CA) 2818539

(51) Int. Cl. E06B 9/56

(52) U.S. Cl. CPC E06B 9/56
USPC 160/170

(57) ABSTRACT

A blind of the type having raise cords, by means of which the blinds can be raised and lowered, comprising a raise cord storage device attached to the building fabric adjacent to the blind, which retrieves and stores the raise cords.

### FIELD OF THE INVENTION

The invention relates to blinds of the type incorporating raise cords, in particular venetian blinds and to a device for storing the raise cords in a safe and secure manner.

### BACKGROUND OF THE INVENTION

Blinds which can be raised and lowered, commonly incorporate raise cords hanging down along one edge of the blind. When the blinds are lowered, the raise cords are lifted up towards the head rail of the blind. However when the blind is raised, the raise cords will extend downwardly. It is found that the raise cords, in some cases, are an accident hazzard. It is desirable therefore to store the raise cords out of harms way. In addition, cord locks are required in the head rail, which impose restrictions on the design of the blind.

In the past, various proposals have been made for controlling the raise cords but they have been less than satisfactory.

### BRIEF SUMMARY OF THE INVENTION

The invention therefore provides a blind of the type having raise cords, by means of which the blinds can be raised and lowered, and incorporating a raise cord storage device attached to the building fabric adjacent to the blind, which retrieves and stores the raise cords when the blind is raised, and from which the raise cords can be released, the blind is lowered.

Preferably, the invention relates to venetian blinds of the type having a plurality of blind slats, and raise cords for raising and lowering the blind slats.

Preferably, the invention provides a self winding reel retractor, to which the cords are attached, so that when the raise cords are extending, during raising of the blind, the free ends of the raise cords are retrieved and retracted into the device automatically.

Preferably the device will incorporate a reel for winding the raise cords, a spring for operating the reel, a housing for enclosing the reel, and having attachment means whereby the housing may be attached to the building fabric and a ratchet type lock which can be operated to stop the reel at a desired position.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is an elevation of a venetian blind, and retractor,

FIG. 2 is a perspective of one housing component;

FIG. 3 is a perspective of another housing component;

FIG. 4 is an exploded perspective illustration showing the housing components and the reel and a spring;

FIG. 5 is an exploded side elevation of the reel;

FIG. 6 is a side elevation of the two reel components assembled;

FIG. 7 is a sectional side elevation of the reel assembly.

### DESCRIPTION OF A SPECIFIC EMBODIMENT

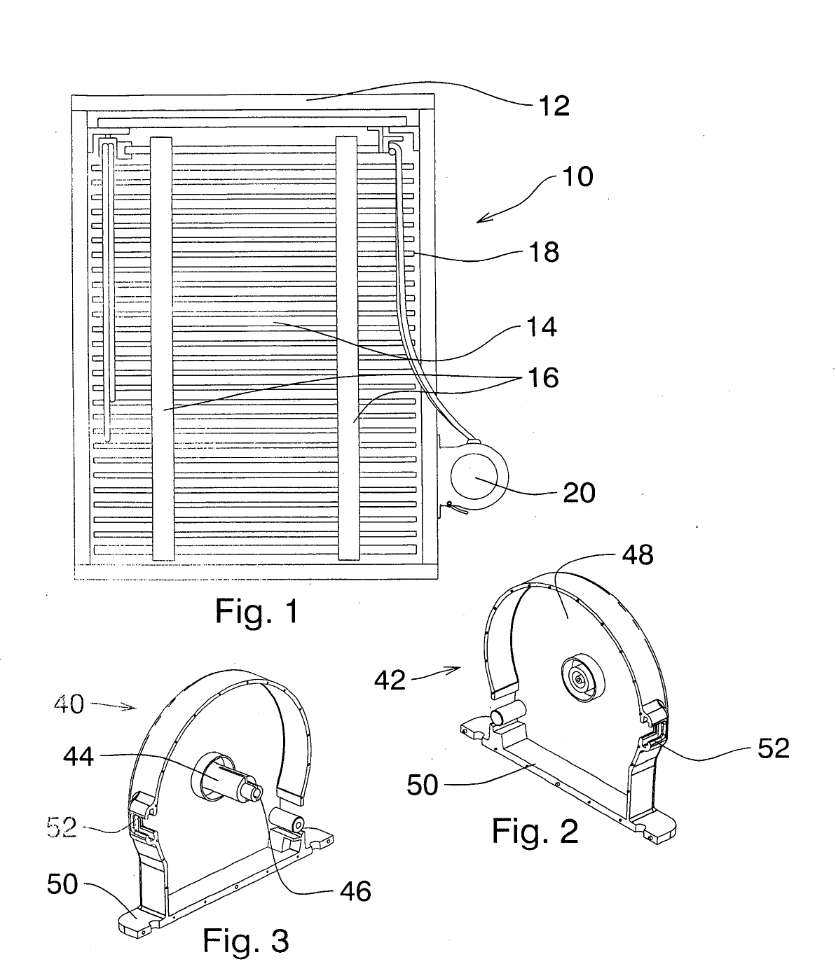

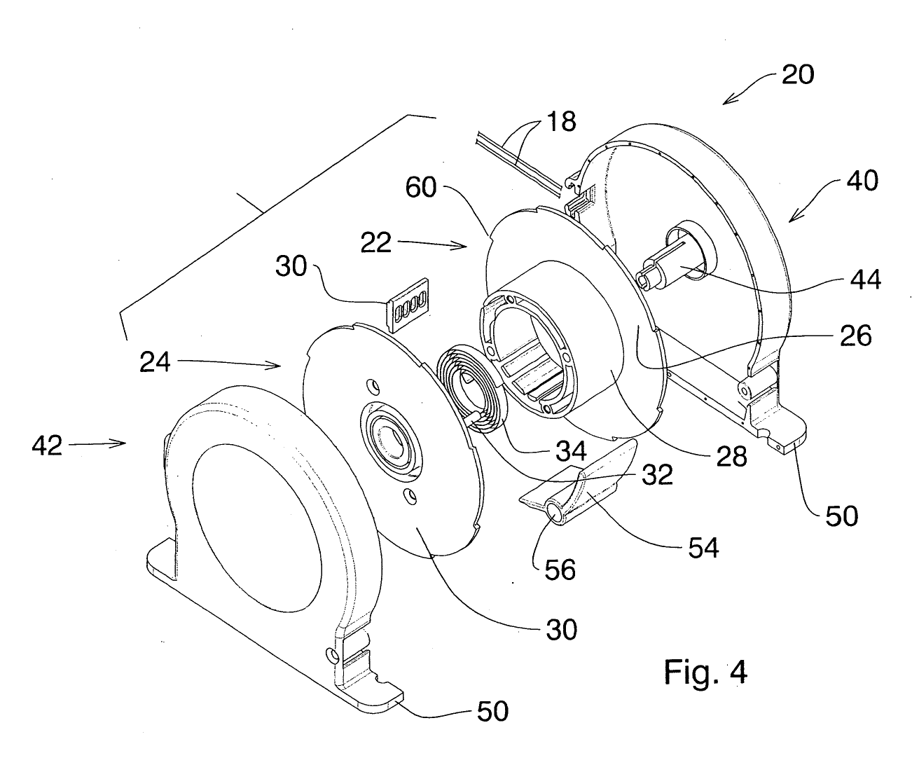

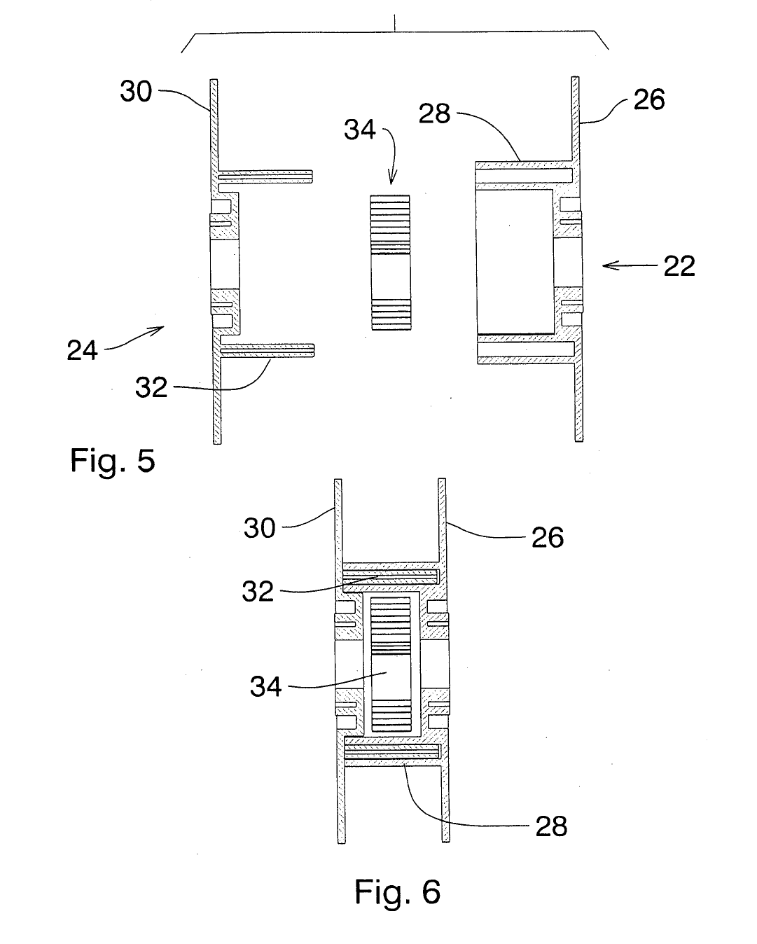

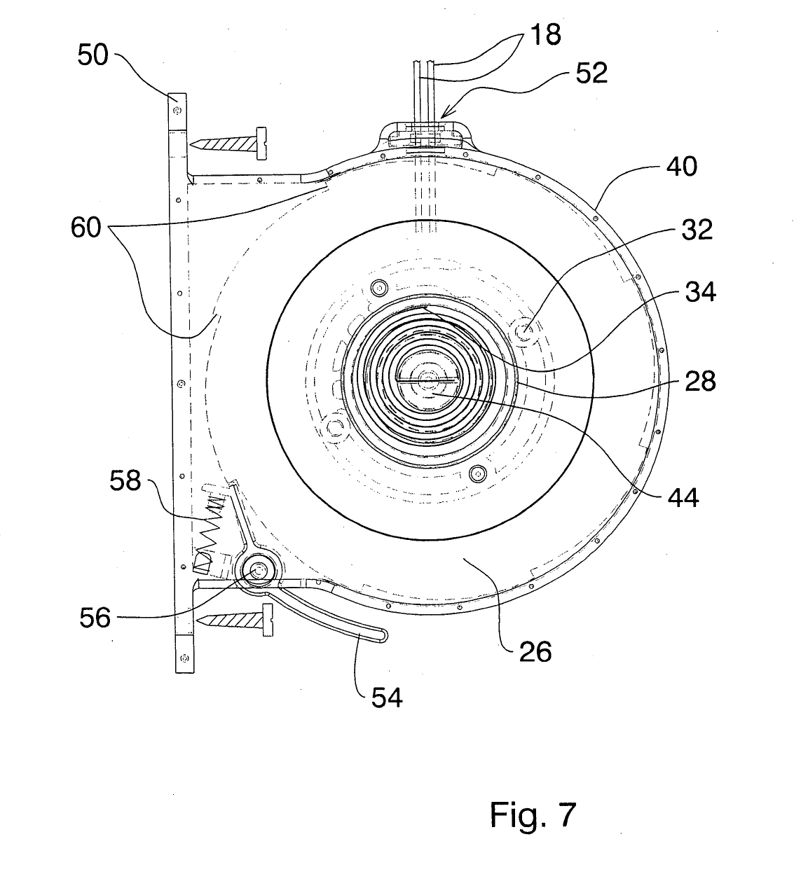

FIG. 1 illustrates the invention in this embodiment, in the form of a typical venetian blind (10), having a head rail (12) and a plurality of horizontal transverse slats (14).

The slats are supported in spaced apart relation on tapes (16).

The tapes can be adjusted by a rod so as to open or close the slats. All of these features are entirely typical of venetian blinds.

The invention is not restricted solely to venetian blinds. It is also applicable to any blinds having raise cords, such as, but not exclusively, to so-called “russian” blinds and balloon blinds, and even single roller blinds.

The slats can be raised, or lowered by means of control or raise cords (18). When the venetian blind slats are raised, the cords will extend in many cases, almost down to the floor, or at any rate, to considerable length below the level of the window opening. This is considered by many to create an undesirable accident hazzard, especially if there are small children in the home.

The invention provides a blind in which these hazzards are substantially eliminated, by providing a cord retractor (20), which retrieves and stores the cords within a housing, and prevents them from hanging down.

Referring now to FIG. 2 onwards, the retractor will be seen to comprise a reel contained within a housing. The reel comprises of two mating portions, namely a right component (22) and a left component (24). The reference to left and right is purely for the sake of simplicity and understanding of the drawings. The component (22) comprises a disc-shaped flange (26), and a central core (28), having a hollow interior.

The component (24) comprises a disc-shaped flange (30) and a mating plug portion (32), which are received within the core (28). The components are held together in any suitable manner such as adhesive.

Within the core (28), a space is provided to receive a coil spring (34), similar to a clock spring. The spring defines an outer end secured to the core (28) and an inner end.

The housing comprises left and right hand parts (40) and (42). The left hand part has a planar outer wall, and a perimeter wall, normal thereto.

A central spindle (44) extends normal to housing part (40). The spindle is provided with a central slot (46) to receive the inner end of the spring. The right hand housing part (42) provides a wall (48), and mating components whereby the parts may be mated with the left hand portion to provide a complete housing.

The housing also provides a planar base (50) with fastening openings, whereby it may be secured to the fabric of a building around a blind or window opening, at a suitable height above the floor to avoid hazzards. Cord entrance slots (52) are secured in the housing. In this case four such slots are provided, for the sake of example.

Many venetian blinds require only two raise cords, so that only two of such slots would be used. Other venetian blinds, on a larger scale, may require four raise cords in which case, four slots would be used.

In order to control rotation of the reel, a plurality of angled teeth (60) are formed in the outer rim of the two reel face plates.

In order to provide a reel lock, a lock lever and tab (54) is provided pivoted at (56). A spring (58) urges the lock up against the edges of the two face plates and therefore engages one pair of the angled teeth (60). In order to allow rotation of the reel, in one direction, the lever (54) is operated by hand to release the reel and allow the cords to be unwound, for lowering of the blind. When the blind is raised, the reel operates in response to the spring, in the opposite direction, and lever (54) will simply act as a ratchet, with the locking lever tripping over each of the teeth as the reel rotates and the cords are wound up.

### IN OPERATION

During manufacture, it is assumed that the spring will have been fully wound, and the reel locked. It is also assumed that the raise cords will have been fed through the slots, and attached to the reel.

When the blind slats are fully lowered, the raise cords are then at their highest position relative to the head rail. In this position, the coil spring will have been fully wound, in the reel. When the raise cords are then operated to raise the blind slats, the lower end of the raise cords will be retracted into the retractor device and into the reel by the operation of the spring. The lock lever will prevent unwinding of the reel, and thereby will function as a means for holding the blind slats at any desired height.

When it is desired to lower the blind slats, then the reel lock tab will be released by one hand and the cord will be withdrawn from the reel thereby winding up the spring and allowing the slats to be lowered. It will thus be seen that the invention provides a means of retaining the surplus ends of the raise cords in a safe and harmless situation, and also assists in the operation of the venetian blind as a whole.

It will also be possible by this means to do away with the conventional raise cord locks which are usually incorporated in the head rail in the venetian blind.

While the invention is described specifically in relation to the application with a venetian blind, it will be appreciated that there are other types of blinds which can also be raised and lowered by raise cords, and the invention is equally applicable to other types of such blinds.

Reference to “tapes” herein is also deemed to include ladders of other material which support the slats.

One advantage of the retractor is that it always keeps the raise cords taut. It is not possible for anyone to hold one of the cords, between the slats, and pull it loose, because the cords are secured in the retractor.

Also the invention makes it possible to lead the raise cords from the very end of the head rail, since the usual cord locks in the head rail are now unnecessary.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A blind of the type having raise cords, by means of which the blind can be raised and lowered, comprising;
a raise cord storage device attachable to the building fabric adjacent to the blind, which retrieves and stores the raise cords.

2. A blind as claimed in claim 1 wherein the blind is a venetian blind of the type having a plurality of blind slats, and having raise cords for raising and lowering the blind slats.

3. A blind as claimed in claim 1 including a self winding reel retractor, to which the cords are attached, so that when the raise cords are extending during raising of the blind, the free ends of the raise cords are retrieved and retracted into the retractor automatically.

4. A blind as claimed in claim 1 including a reel for winding the raise cords, a spring operating the reel, a housing enclosing the reel, and having attachment means whereby the housing may be attached to the building fabric and a ratchet type lock to stop the reel at a desired position.

5. A blind as claimed in claim 4 wherein the reel comprises two reel components, each said component defining a side wall and teeth in said side wall, and mateable parts on said reel components whereby they may be mated together to form said reel.

6. A blind as claimed in claim 5 including recesses defined in said mateable parts for receiving said spring.

7. A blind as claimed in claim 5 wherein said housing comprises right and left housing parts, one of said parts defining a central spindle and attachment means for attaching one end of said spring thereto, and wherein the reel mateable components define a spring attachment for attaching the opposite end of said spring.

8. A blind as claimed in claim 7 and including a reel locking lever and spring biassing means in said housing urging said locking lever into engagement with said teeth.

9. A blind as claimed in claim 8 and including a plurality of entrance openings in said housing, for receiving said raise cords therethrough.

10. A blind as claimed in claim 9 including a lock lever member swingably mounted in said housing and a spring urging said lever into engagement with said teeth on said reel, and a tab on said lock lever member extending from said housing, for manual operation.
